(19) United States
(12) Patent Application Publication
(10) Pub. No.: US 2003/0093902 A1
(43) Pub. Date: May 22, 2003

(54) Device and method for manufacturing fluid bearings

(76) Inventors: Hung-Kuang Hsu, Hsinchu (TW); Chia-Lung Kuo, Yun-Lin Hsien (TW); Mei-Lin Lai, Hsinchu (TW); Kuang-Hsien Chang, Hsinchu (TW); Ching-Hsing Huang, Hsinchu (TW); Min-Der Wu, Taichung (TW)

Correspondence Address: BIRCH STEWART KOLASCH & BIRCH, PO BOX 747, FALLS CHURCH, VA, 22040-0747, US

(21) Appl. No.: 10/076,487

(22) Filed: Feb. 19, 2002

(30) Foreign Application Priority Data
Nov. 16, 2001 (TW) 90128404

(51) Int. Cl. B23P 19/04; B21D 53/10; B21K 1/10

(52) U.S. Cl. 29/898.02; 29/724

(57) ABSTRACT

The specification discloses a device and method for manufacturing fluid bearings. The invention utilizes the electromagnetic forming method to manufacturing fluid bearings. The method uses a high speed plastic forming means to produce a dynamic pressure generating groove on the internal peripheral surface of the bearing. It further makes use of different thermal expansion coefficients for an internal mold and a raw sleeve to perform separation from the mold. Through the above-mentioned process, fluid bearings can be successfully made. This method can effectively prevent the problem springback and crease of the material during formation.

### BACKGROUND OF THE INVENTION

1. Field of Invention

The invention relates to a device and method for manufacturing fluid bearings. In particular, an electromagnetic forming method is employed to produce a dynamic pressure generating groove on the inner peripheral surface of the bearing so that lubricant film pressure and lubricant sealing effects can be achieved during the operation.

2. Related Art

Bearings are devices used to support, bear loads and minimize friction in rotary machine parts. Ball bearings are one type of commonly seen bearings. However, there are problems such as big rotation noises, less precision and difficulty in miniaturization. They will not be precise enough when used in small device in the future. For small machine parts or precision electronics, such as fans in computer systems, CD-ROM, and HDD (Hard Disk Drive), one has to choose tiny, little rotation noises, low rotational friction and vibration resistant bearings. The invention of fluid bearings indeed solves some of the problems in the prior art.

Fluid bearings can be grouped into two types: hydrostatic bearings and hydrodynamic bearings. The hydrostatic bearings have lots of fluid lubricant inside the bearing at its normal state. Therefore, they are not suitable for small rotary machine parts that require high precision. The hydrodynamic bearings have fine dynamic pressure generating grooves on the inner peripheral surface of the bearings, and lubricant is inside the grooves. Since the grooves are tiny, there is only very little lubricant. Consequently, lubricant film pressure and lubricant sealing effects can be achieved during rotation. As current spindle motors are designed smaller, it is hard to make fluid bearings that meet the high precision requirements by tiny motors (which is because there are strict requirements on the dynamic pressure generating groove depth, width and concentricity). The conventional precision machining method is likely to produce burrs at the bearing grooves, to have worse concentricity, and to have such problems as serious abrasion to the cutting-tools. Conventional technologies such as the U.S. Pat. No. 5,758,421 granted to Asada and the U.S. Pat. No. 5,265,334 to Lucier both use hard compresses using metal balls to produce tiny grooves. This type of techniques has three drawbacks: (1) the mold metal ball has a very small contact area with the forming material, and thus is susceptible to abrasion; (2) the metal ball is so small that its clamping apparatus is hard to design; and (3) a precision positioning and control platform is required during the rolling, thus the manufacturing cost is higher. The U.S. Pat. No. 6,074,098 conferred to Asai makes the bearings by plastic injection molding method. Since this method performs mold separation by force, the precision of the inner peripheral surface of the bearing is worse and the bearing is not abrasion resistant. The U.S. Pat. No. 5,914,832 conferred to Teshima makes the plate thrust bearing by chemical etching. The U.S. Pat. No. 6,108,909 granted to Cheever makes the dynamic groove of the bearing by roller ramming method. Both of these methods cannot form the inner peripheral surface of the bearing.

The above-mentioned methods are not suitable for mass production and have higher manufacturing costs. Therefore, how to utilize the electromagnetic forming method to manufacture fluid bearings in a mature way to lower the cost while increasing the yield is indeed a subject that needs some technical breakthroughs.

### SUMMARY OF THE INVENTION

To solve the foregoing problems, the invention provides a device and method for manufacturing fluid bearings. The invention uses the electromagnetic forming method, which has the characters of ultrahigh speed and high energy rate plastic forming, to produce a tiny dynamic pressure generating groove on the inner peripheral surface of the bearing. Such a device and method can guarantee high product precision and high production efficiency.

Another objective of the invention is to provide a method of mold separation using temperature difference. One has to find an internal mold and a raw sleeve materials with different thermal expansion coefficients. Once a product is formed, one only needs to heat up or cool down the system to an appropriate temperature for mold separation. When the internal mold and the parts are separate, one can readily take out the product parts.

### BRIEF DESCRIPTION OF THE DRAWINGS

The invention will become more fully understood from the detailed description given herein below illustration only, and thus are not limitative of the present invention, and wherein:

FIG. 1 is a schematic view of the disclosed manufacturing method;

FIG. 2 is a schematic view of the power supply unit;

FIG. 3 is a cross-sectional view of the formed bearing;

FIG. 4 is a schematic view of the second embodiment of the invention; and

FIG. 5 shows the steps of manufacturing the fluid bearings using the electromagnetic forming method.

### DETAILED DESCRIPTION OF THE INVENTION

The electromagnetic forming method is a high energy rate forming method, which can form metal instantaneously. This method of increasing the metal forming speed can indeed improve the formation of materials. The reason is that when metal is formed at a very high speed, the metal is just like fluid; this is also why the problems of springback and crease can be effectively avoided during the formation. This method can overcome many limitations in traditional machining that will result in plastic deformation. Generally speaking, the traditional mechanical forming method has a speed around 0.03˜0.73 m/sec. The high energy rate forming method, however, can reach a speed between 27 m/sec and 228 m/sec. One thus sees a huge difference between them.

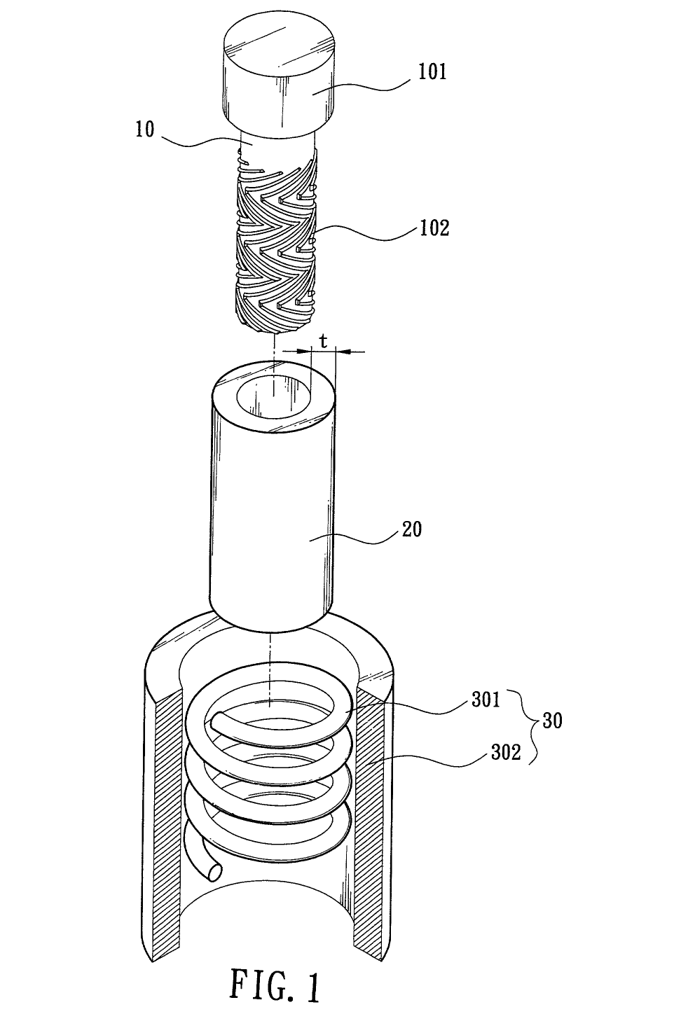

An embodiment is used hereinafter to demonstrate the feasibility of the disclosed method. With reference to FIG. 1, the device of manufacturing fluid bearings has an internal mold 10, a raw sleeve 20 and a magnetic field generating unit 30. The internal mold 10 has a molding puller 101, which is used to clamp the mold after the products are formed and ready for separation so that the machine can readily take out the products. The internal mold 10 further has a plurality of ribs 102, which are used to form grooves on the inner peripheral surface of the bearing of the raw sleeve 20. The raw sleeve 20 is a cylindrical tube with a thickness t. The internal mold 10 is inserted into the raw sleeve 20. In this embodiment, the magnetic field generating unit 30 is composed of a solenoid 301 and supporting element 302. The solenoid 301 is made of spiral conductive material. It is connected to a power supply 40 by both ends, coiling around the raw sleeve 20. The supporting element 302 surrounds the solenoid 301. The quality of the product is determined by the homogeneity and symmetry of the magnetic field the solenoid 301 produces.

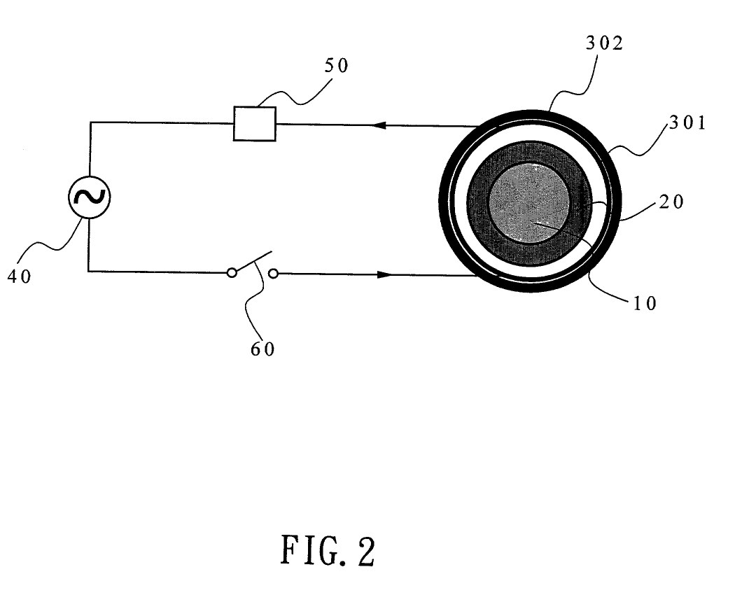

Since the fluid bearings are manufactured by using the electromagnetic forming method, the raw sleeve 20 and the solenoid 301 have to be both conductive. With regard to the power supply 40, please refer to FIG. 2. The internal mold 10 is put inside the raw sleeve 20, which is then surrounded by the solenoid 301. Both ends of the solenoid 301 are connected to a power supply 40, a charge/discharge device 50, and a switch 60 to form a loop. The solenoid 301 is further surrounded by the supporting element 302. For example, the solenoid 301 can be surrounded by a cylindrical rigid tube to counteract the reaction force from the raw sleeve 20 during formation, thus avoiding breaks or deformation. First, the power supply 40 charges the charge/discharge device 50 until it is saturated. Afterwards, the switch 60 closes to produce instantaneous discharge. A huge pulse current flows through the solenoid 301 to generate instantaneously a strong magnetic field. The raw sleeve 20 then generates a resistant eddy current immediately. The eddy current in the external magnetic field has a big repulsive force to push the raw sleeve 20 toward inside, producing material deformation. Therefore, using the electromagnetic forming method to perform plastic forming does not need an external mold and the exerted force is non-contact. This can effectively reduce the manufacturing costs.

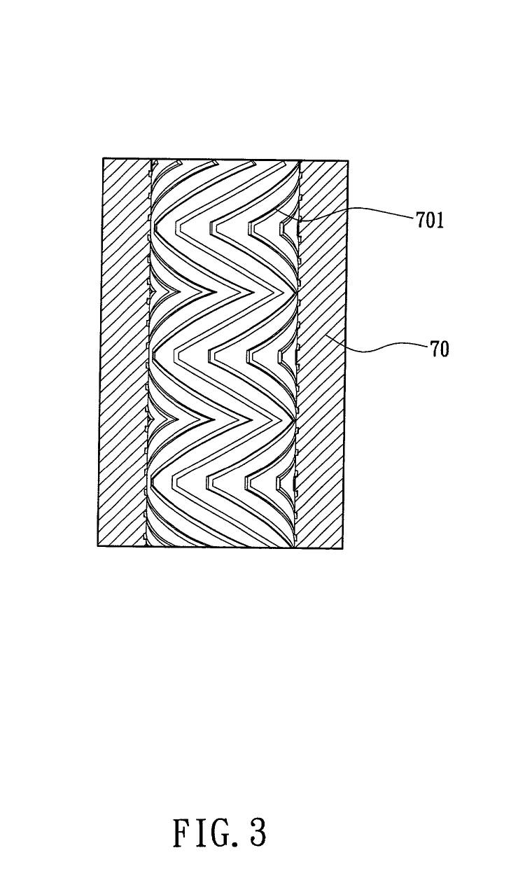

The final product of the fluid bearing manufactured using the electromagnetic forming method is shown in FIG. 3. A dynamic pressure generating groove 701 inside the fluid bearing product 70 is the channel for lubricant. The dynamic pressure generating groove 701 ensures the lubricant film pressure and lubricant sealing effects during the rotation of the bearings. The depth of the dynamic pressure generating groove 701 is shallow, usually between 0.002 m and 0.02 m. Traditional forming methods have the problem of imperfect fluidity of the formation material, which results in being unable to produce precision fluid bearings. Consequently, using the electromagnetic forming method for production is indeed a better choice.

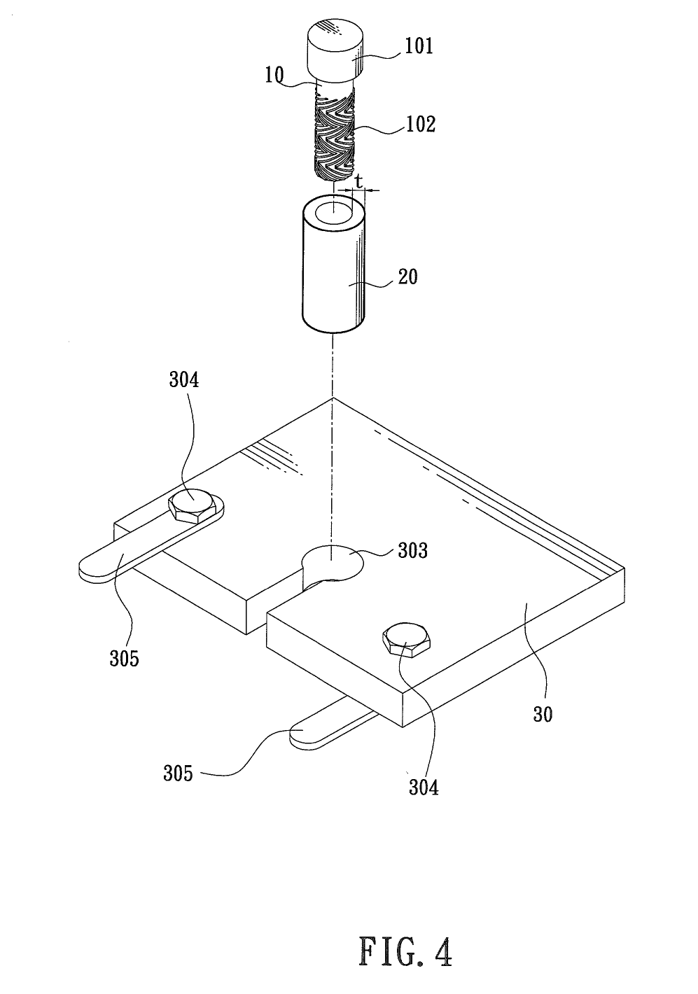

A second embodiment of the invention is shown in FIG. 4. The magnetic field generating unit 30 in practice can be a flat conductive material with a circular hole 303, a bolt 304, and an electrode 305. The internal mold 10 is put inside the raw sleeve 20, which is then put in the circular hole 303 of the magnetic field generating unit 30. The second circular hole 303 can be used as a spare in case the previous circular hole is damaged so that the whole device is unable to function. The power supply 40 of the magnetic field generating unit 30 is from a power supply unit through the electrode 305. To avoid separation of the electrode 305 from the conductive material, it is locked onto the conductive material by the bolt 304. The design, manufacturing principles and processes are the same as the previous embodiment and, therefore, are not repeated here.

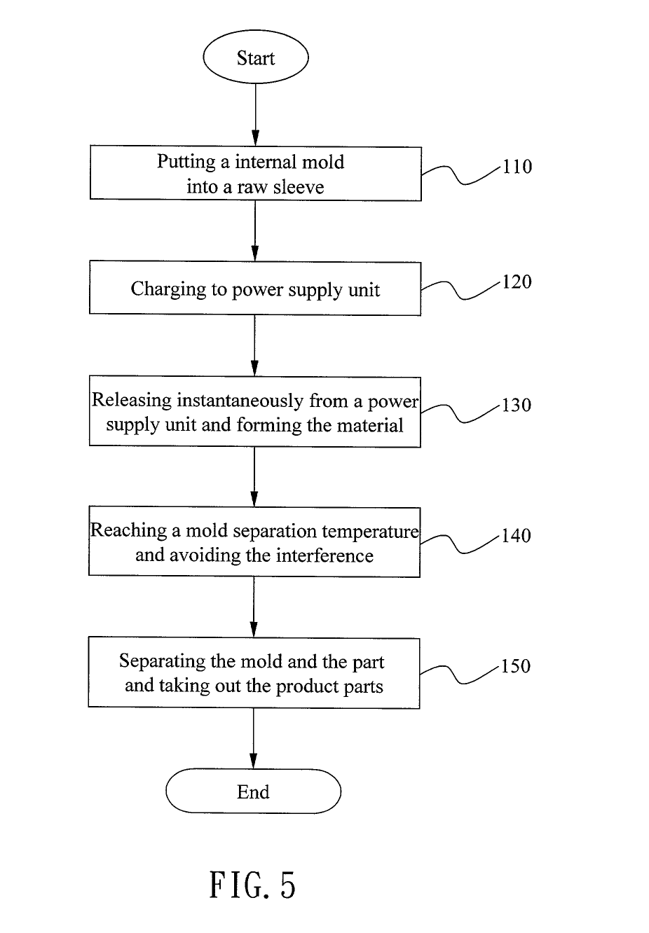

With reference to FIG. 5, a finished internal mold is put inside a raw sleeve (step 110). A power supply unit starts to charge a charge/discharge device (step 120). Once fully charged, the charge/discharge device instantaneously releases its charges, forming the material (step 130). Finally, one has to separate and take out the mold. The mold separation has to be taken in account when designing the mold. Therefore, the mold is made into separable parts. However, when making the mold of the fluid bearings, such a separable mold results in two problems: (1) the precision becomes worse, and (2) the mold is too small for machining. Therefore, we do not consider the separable mold for manufacturing the fluid bearings. The precision fluid bearing has a characteristic that the groove on the inner peripheral surface of the bearing. Therefore, it is preferable to choose an internal mold material with a small thermal expansion coefficient and a raw sleeve with a bigger thermal expansion coefficient. After the formation, one only needs to heat up or cool down the working piece to an appropriate temperature to separate the mold. The internal mold and the product thus do not have any interference with ribs and the groove (step 140). After the mold separation, one obtains fluid bearings with high precision and no burrs (step 150). The aforementioned appropriate temperature is determined in accordance with material properties (thermal expansion coefficients). For example, suppose the internal mold is made of steel, then its thermal expansion coefficient is 0.11×10⁻⁴/° C.; if the raw sleeve is aluminum alloy, then the thermal expansion coefficient is 0.24×10⁻⁴/° C. If one wants to have a mold separation tolerance of 2 μm, then the temperature needs to be raised to 103° C. to avoid interference. For a tolerance of 5 μm, a temperature of 256° C. is required to have successful mold separation. Furthermore, with a proper arrangement of the thermal expansion coefficients of the internal mold and raw sleeve, one can achieve a similar effect through cooling.

Effects of the Invention

Using the disclosed device and method for manufacturing fluid bearings can prevent such problems as burrs, imperfect concentricity of the dynamic pressure generating grooves, difficulty preparing, and easily abrasion in cutting-tools. Therefore, the invention has the following advantages:

1 It does not need an external mold, greatly simplifying the process of making molds and lowering the manufacturing costs.

2 In comparison with the prior art, the disclosed method has the shortest cycle time and thereby increases the yield.

3 The grooves of the fluid bearings thus manufactured have a higher precision and no burrs.

4 The device does not need a precision positioning platform. Instead, it only requires a precision mold. Therefore, the invention has fewer costs in purchasing and maintaining apparatuses.

What is claimed is:

1. A device for manufacturing fluid bearings, which comprises:
a raw sleeve in a tube shape;
an internal mold, which has a plurality of protruding ribs on its surface and is put inside the raw sleeve;
a magnetic field generating unit, which surrounds the raw sleeve, and under an imposed current, generates an instantaneous magnetic force to extrude the raw sleeve toward the center of the raw sleeve, so that the plurality of ribs on the internal mold surface form a plurality of dynamic pressure generating grooves on the raw sleeve; and
a power supply unit, which is comprised of a power supply, a charge/discharge device, and a switch to provide the current for the magnetic field generating unit to produce a required magnetic force.

2. The device of claim 1, wherein the thermal expansion coefficient of the internal mold is smaller than that of the raw sleeve.

3. The device of claim 1, wherein the ribs of internal mold surface protrudes outwards in the radial direction.

4. The device of claim 1, wherein the magnetic field generating unit is comprised of a solenoid and a supporting element.

5. The device of claim 4, wherein the material of the solenoid is selected from the group consisting of silver, tungsten, copper, aluminum, aluminum alloys, and copper alloys that have good electrical conductivity.

6. The device of claim 4, wherein the supporting element is used to counteract the reaction force from the raw sleeve during its formation, preventing the solenoid from deformation and breaking.

7. The device of claim 1, wherein the magnetic field generating unit is a conductive material with a circular hole to accommodate the raw sleeve.

8. The device of claim 1, wherein the charge/discharge device is a capacitor.

9. The device of claim 1, wherein the charge/discharge device is an inductor.

10. A method for manufacturing fluid bearings, which comprises the steps of:
providing a cylindrical tube of raw sleeve and an internal mold with a plurality of ribs on its surface, the ribs protruding from the internal mold surface toward the radial direction;
putting the internal mold in the raw sleeve;
providing a magnetic field generating unit surrounding the raw sleeve, the magnetic field generating field being powered by an external source to produce a required magnetic field;
producing a non-contact external force from the magnetic field generating unit to extrude the raw sleeve toward inside along the radial direction, so that the plurality of ribs on the internal mold surface forms a plurality of dynamic pressure generating grooves on the raw sleeve; and
performing mold separation by reaching a mold separation temperature, so that the internal mold and the raw sleeve do not interfere with each other and are separable.

11. The method of claim 10, wherein the non-contact force is a pulse magnetic force.

12. The method of claim 10, wherein the mold separation is achieved by having the thermal expansion coefficient of the internal mold smaller than that of the raw sleeve.
